(19) United States
(12) Patent Application Publication
(10) Pub. No.: US 2020/0368740 A1
(43) Pub. Date: Nov. 26, 2020

(54) COLORIMETRIC DETECTION SENSOR COMPRISING WATER-SOLUBLE CHITOSAN DERIVATIVE

(71) Applicant: GWANGJU INSTITUTE OF SCIENCE AND TECHNOLOGY, Gwangju (KR)

(72) Inventors: Min Gon KIM, Gwangju (KR); Hyung Jun JANG, Gwangju (KR)

(21) Appl. No.: 16/880,437

(22) Filed: May 21, 2020

(30) Foreign Application Priority Data
May 24, 2019 (KR) 10-2019-0061141

(51) Int. Cl. B01L 3/00; G01N 21/78

(52) U.S. Cl. CPC B01L 3/502; G01N 21/78; B01L 2200/12; B01L 2300/12; B01L 2300/0627; B01L 2300/044

(57) ABSTRACT

A colorimetric detection sensor includes a porous membrane and a detection unit formed on the porous membrane. The detection unit includes a water-soluble chitosan derivative and a color-developing reagent.

### BACKGROUND OF THE INVENTION

### Field of the Invention

The present invention relates to a colorimetric detection sensor including a water-soluble chitosan derivative. Specifically, the present invention relates to a colorimetric detection sensor having an excellent colorimetric concentration effect, which includes a porous membrane and a detection unit formed on the porous membrane and including a water-soluble chitosan derivative and a color-developing reagent.

### Description of the Related Art

A disease indicator substance present at a low concentration in body fluids of the body is generally measured using an enzymatic reaction and a biological reaction such as antigen-antibody attachment. Since an enzyme and an antibody have high reaction specificity for selectively recognizing a substrate and high reaction efficiency, an analyte may be measured with high sensitivity. However, since most diagnostic systems using these reaction characteristics require expensive analytical equipment and human resources with specialized knowledge, the physical accessibility for rapid diagnosis is relatively limited.

A paper-based sensor is a technology that implements a diagnostic reaction system on paper or a similar material, and is inexpensive, convenient, and easy to mass-produce due to the characteristics of the raw material. In this regard, the paper-based sensor is a technology that ideally satisfies the requirements for point-of-care testing.

Representative examples of a conventional paper-based sensor include an immunochromatographic strip (for example, a pregnancy test kit and a malaria test kit), a dip stick (for example, urinalysis test paper), and the like, and the conventional paper-based sensor has been commercialized and used since the mid-1970s.

However, the existing paper-based sensor causes a problem in that the color intensity is dispersed and an inconvenience in which a detection site needs to be set every time when signals are measured using a detector, because the degree of spread varies depending on the part of the detection unit.

In order to overcome the above problems, studies have been conducted, such as a method of patterning a membrane and a method for manufacturing a sensor using a polymer, but the above methods increase the processes of manufacturing a sensor, incur an additional cost, and have a problem in that signals are not perfectly concentrated in spite of these processes.

### SUMMARY OF THE INVENTION

An object of the present invention is to provide a colorimetric detection sensor including a water-soluble chitosan derivative.

Another object of the present invention is to provide a biological sample analyzer capable of point-of-care testing.

In order to solve the aforementioned problem in that the color intensity is dispersed, the present inventors have found that the color intensity is concentrated by a simple process of spotting a porous membrane with a water-soluble chitosan derivative, thereby completing the invention for a colorimetric detection sensor.

An aspect of the present invention provides a colorimetric detection sensor including a porous membrane and a detection unit formed on the porous membrane and including a water-soluble chitosan derivative and a color-developing reagent.

In an exemplary embodiment of the present invention, the water-soluble chitosan derivative may be any one selected from the group consisting of chitosan oligosaccharide lactate (COL), glycol chitosan (GC), methyl glycol chitosan (MGC), N-carboxymethyl chitosan, N-hydroxymethyl chitosan, N-hydroxypropyl chitosan, N-hydroxypropyl ether chitosan, and a combination thereof.

In an exemplary embodiment of the present invention, the water-soluble chitosan derivative may have a molecular weight of 1 kDa to 150 kDa.

In an exemplary embodiment of the present invention, the water-soluble chitosan derivative may block pores of the porous membrane.

In an exemplary embodiment of the present invention, the porous membrane may be any one selected from the group consisting of nitrocellulose, nylon, polysulfone, polyethersulfone, polyvinylidene fluoride (PVDF), and a combination thereof.

In an exemplary embodiment of the present invention, the color-developing reagent may include an oxidase, a peroxidase, and a chromophore.

In an exemplary embodiment of the present invention, the oxidase may be any one selected from the group consisting of glucose oxidase, galactose oxidase, lactate oxidase, pyruvate oxidase, glutamate oxidase, alcohol oxidase, ascorbate oxidase, cholesterol oxidase, choline oxidase, uricase, and a combination thereof.

In an exemplary embodiment of the present invention, the peroxidase may be any one selected from the group consisting of soybean ascorbate peroxidase, arabidopsis ascorbate peroxidase, spinach ascorbate peroxidase, horseradish peroxidase (HRP), and a combination thereof.

In an exemplary embodiment of the present invention, the chromophore may be any one selected from the group consisting of tetramethylbenzidine (TMB), 3,3-diaminobenzidine (DAB), 4-aminoantipyrine (4-AAP), N-ethyl-N-(2-hydroxy-3-sulfopropyl)-3,5-dimethylaniline (MAOS), N-ethyl-N-(2-hydroxy-3-sulfopropyl)-3-methoxyaniline (ADOS), N-ethyl-N-(3-sulfopropyl)-3-methoxyaniline (ADPS), N-ethyl-N-(3-sulfopropyl)aniline (ALPS), N-ethyl-N-(2-hydroxy-3-sulfopropyl)-3,5-dimethoxyaniline (DAOS), N-(2-hydroxy-3-sulfopropyl)-3,5-dimethoxyaniline (HDAOS), N,N-bis(4-sulfobutyl)-3,5-dimethylaniline (MADB), N,N-bis(4-sulfobutyl)-3-methylaniline (TODB), N-ethyl-N-(2-hydroxy-3-sulfopropyl)-3-methylaniline (TOOS), N-ethyl-N-(3-sulfopropyl)-3-methylaniline (TOPS), and a combination thereof.

In an exemplary embodiment of the present invention, two or more detection units are present, and the detection unit may simultaneously detect two or more substrates.

An aspect of the present invention provides a biological sample analyzer including the colorimetric detection sensor.

In an exemplary embodiment of the present invention, the biological sample analyzer may be capable of point-of-care testing (POCT).

An aspect of the present invention provides a method for manufacturing a colorimetric detection sensor, the method including: preparing a detection mixture solution by mixing a water-soluble chitosan derivative and a color-developing reagent; spotting a porous membrane with the detection mixture solution; and forming a detection unit by drying the porous membrane spotted with the detection mixture solution.

In an exemplary embodiment of the present invention, the color-developing reagent may include an oxidase, a peroxidase, and a chromophore.

In an exemplary embodiment of the present invention, the water-soluble chitosan derivative may be included in an amount of 0.1 wt % to 5 wt % based on the total weight of the detection mixture solution.

In an exemplary embodiment of the present invention, the detection mixture solution may be spotted at 0.1μL to 5μL.

### BRIEF DESCRIPTION OF THE DRAWINGS

FIGS. 1(a) to 1(d) are graphs illustrating the difference in color intensity depending on the concentrations of uricase (a), HRP (b), MADB (c) and 4-AAP (d) among the color-developing reagents prepared according to an exemplary embodiment of the present invention;

FIGS. 2(a) and 2(b) are SEM photographs illustrating the surfaces of a colorimetric detection sensor manufactured according to an exemplary embodiment of the present invention (a) and the control (b);

FIG. 3 is a detection schematic view of a colorimetric detection sensor manufactured according to an exemplary embodiment of the present invention;

FIGS. 4(a) to 4(e) are photographs illustrating the detection experimental results of a colorimetric detection sensor manufactured according to an exemplary embodiment of the present invention (a, b, and c) and the comparative example (d and e);

FIGS. 5(a) and 5(b) illustrate a photograph and a graph of detection experimental results of a colorimetric detection sensor manufactured according to an exemplary embodiment of the present invention depending on the concentrations of glucose (a) dissolved in ultrapure water and uric acid (b) dissolved in ultrapure water;

FIGS. 6(a) to 6(d) illustrate photographs and graphs of detection experimental results of a colorimetric detection sensor manufactured according to an exemplary embodiment of the present invention depending on the concentrations of glucose (a and b) dissolved in ultrapure water and glucose (c and d) in human urine;

FIGS. 7(a) and 7(b) are graphs of spike experimental results of a colorimetric detection sensor manufactured according to an exemplary embodiment of the present invention depending on the concentrations of glucose (a) dissolved in ultrapure water and glucose (b) in human urine;

FIGS. 8(a) to 8(d) illustrate graphs and photographs of direct (a and b) and inverse slope (c and d) experimental results of multiple experiments of a colorimetric detection sensor manufactured according to an exemplary embodiment of the present invention;

FIG. 9 is a graph of experimental results of multiple experiments of a colorimetric detection sensor manufactured according to an exemplary embodiment of the present invention; and

FIGS. 10(a) and 10(b) are graphs evaluating the stability of a colorimetric detection sensor manufactured according to an exemplary embodiment of the present invention when glucose (a) and uric acid (b) are detected.

### DETAILED DESCRIPTION OF THE PREFERRED EMBODIMENTS

Hereinafter, the present invention will be described with reference to the accompanying drawings. However, the present invention can be realized in various different forms, and is not limited to the Examples described herein. Moreover, in the accompanying drawings, parts that are not related to the description will be omitted in order to clearly describe the present invention.

Throughout the specification, when one part is “connected (joined, contacted, bonded)” to another part, this includes not only a case where they are “directly connected to each other”, but also a case where they are “indirectly connected to each other” with another member therebetween. Further, when one part “includes” one constituent element, unless otherwise specifically described, this does not mean that another constituent element is excluded, but means that another constituent element may be further included.

The terms used in the present specification are used only to describe specific embodiments, and are not intended to limit the present invention. Singular expressions include plural expressions unless the singular expressions have definitely opposite meanings in the context.

An aspect of the present invention provides a colorimetric detection sensor including a porous membrane and a detection unit formed on the porous membrane and including a water-soluble chitosan derivative and a color-developing reagent.

In an exemplary embodiment of the present invention, the porous membrane may be any one selected from the group consisting of nitrocellulose, nylon, polysulfone, polyethersulfone, polyvinylidene fluoride (PVDF), and a combination thereof, for example, nitrocellulose, but is not limited thereto.

The porous membrane may be used as a substrate of a sensor using the flow of a fluid by a capillary force through internal pores. For example, when the biological sample solution is injected into a part of the porous membrane, the biological sample solution may move up to the other part of the porous membrane, for example, a detection unit, separated from the injected part through the fluid flow of the porous membrane.

In an exemplary embodiment of the present invention, the water-soluble chitosan derivative may be any one selected from the group consisting of chitosan oligosaccharide lactate (COL), glycol chitosan (GC), methyl glycol chitosan (MGC), N-carboxymethyl chitosan, N-hydroxymethyl chitosan, N-hydroxypropyl chitosan, N-hydroxypropyl ether chitosan, and a combination thereof, for example, chitosan oligosaccharide lactate (COL).

The water-soluble chitosan derivative does not need to be mixed with another material for being mixed with a water-soluble color-developing reagent, and thus may easily exhibit the effect of color-developing concentration.

For example, in the case of hydrophobic chitosan, acetic acid needs to be added in order to be mixed with the water-soluble color-developing reagent, which may reduce color development.

The water-soluble chitosan derivative may block pores of the porous membrane.

The water-soluble chitosan derivative may form a film between pores by increasing the wall thickness of the membrane, thereby controlling the flow of a fluid flowing to the end of the membrane to induce color concentration.

The water-soluble chitosan derivative may have a molecular weight of 1 kDa to 150 kDa, for example, 5 kDa. When the water-soluble chitosan derivative has a molecular weight of less than 1 kDa, the wall thickness of the membrane may not be effectively increased, and when the water-soluble chitosan derivative has a molecular weight of more than 150 kDa, pores of the membrane may not uniformly blocked.

For example, chitosan oligosaccharide lactate (COL, 5 kDa) may effectively exhibit colorimetric concentration compared to chitosan (141, kDa), which may be because the molecular weight of a low-molecular water-soluble chitosan derivative enables a film to be filled compactly and uniformly, thereby delaying the flow of a solution passing through pores of the film after every treated surrounding environments become wet.

For example, by using the low-molecular water-soluble chitosan derivative, it is possible to provide a colorimetric detection sensor in which the colorimetry is concentrated in a detection unit without performing separate process such as patterning.

The detection unit is formed on a membrane, and is formed by drip-dropping a detection mixture solution including a water-soluble chitosan derivative and a color-developing reagent and then drying the detection mixture solution.

As used herein, the term “formed on the membrane” includes that the detection unit is formed on all or a part of the spotted membrane in the vertical direction.

As used herein, the term “detection unit” means a part in which color development occurs when a substrate of a biological sample is brought into contact with a detection mixture solution, and quantitative detection can be achieved by a method of measuring color intensity at a color-developing part of the detection unit.

In an exemplary embodiment of the present invention, the color-developing reagent may include an oxidase, a peroxidase, and a chromophore.

The oxidase may be any one selected from the group consisting of glucose oxidase, galactose oxidase, lactate oxidase, pyruvate oxidase, glutamate oxidase, alcohol oxidase, ascorbate oxidase, cholesterol oxidase, choline oxidase, uricase, and a combination thereof, for example, glucose oxidase, uricase, or a mixed enzyme of glucose oxidase and uricase.

The peroxidase may be any one selected from the group consisting of soybean ascorbate peroxidase, arabidopsis ascorbate peroxidase, spinach ascorbate peroxidase, horseradish peroxidase (HRP), and a combination thereof, for example, horseradish peroxidase (HRP).

The chromophore may be any one selected from the group consisting of tetramethylbenzidine (TMB), 3,3-diaminobenzidine (DAB), 4-aminoantipyrine (4-AAP), N-ethyl-N-(2-hydroxy-3-sulfopropyl)-3,5-dimethylaniline (MAOS), N-ethyl-N-(2-hydroxy-3-sulfopropyl)-3-methoxyaniline (ADOS), N-ethyl-N-(3-sulfopropyl)-3-methoxyaniline (ADPS), N-ethyl-N-(3-sulfopropyl)aniline (ALPS), N-ethyl-N-(2-hydroxy-3-sulfopropyl)-3,5-dimethoxyaniline (DAOS), N-(2-hydroxy-3-sulfopropyl)-3,5-dimethoxyaniline (HDAOS), N,N-bis(4-sulfobutyl)-3,5-dimethylaniline (MADB), N,N-bis(4-sulfobutyl)-3-methylaniline (TODB), N-ethyl-N-(2-hydroxy-3-sulfopropyl)-3-methylaniline (TOOS), N-ethyl-N-(3-sulfopropyl)-3-methylaniline (TOPS), and a combination thereof, for example, a mixture of 4-AAP and N,N-bis(4-sulfobutyl)-3,5-dimethylaniline (MADB).

As the chromophore, for example, tetramethyl-benzidine (TMB) or 3,3-diaminobenzidine (DAB) may be independently used, and any one of N-ethyl-N-(2-hydroxy-3-sulfopropyl)-3,5-dimethylaniline (MAOS), N-ethyl-N-(2-hydroxy-3-sulfopropyl)-3-methoxyaniline (ADOS), N-ethyl-N-(3-sulfopropyl)-3-methoxyaniline (ADPS), N-ethyl-N-(3-sulfopropyl)aniline (ALPS), N-ethyl-N-(2-hydroxy-3-sulfopropyl)-3,5-dimethoxyaniline (DAOS), N-(2-hydroxy-3-sulfopropyl)-3,5-dimethoxyaniline (HDAOS), N,N-bis(4-sulfobutyl)-3,5-dimethylaniline (MADB), N,N-bis(4-sulfobutyl)-3-methylaniline (TODB), N-ethyl-N-(2-hydroxy-3-sulfopropyl)-3-methylaniline (TOOS), and N-ethyl-N-(3-sulfopropyl)-3-methylaniline (TOPS) may be mixed with 4-aminoantipyrine (4-AAP) and used in the form of a mixture.

As used herein, the term “enzyme” means a material which serves as a catalyst which lowers the activation energy of a reaction by binding to a substrate to form an enzyme-substrate complex. The enzyme is characterized by having a substrate specificity that reacts only with a specific substrate.

The oxidase produces hydrogen peroxide by oxidizing a substrate of a biological sample, the peroxidase serves to promote the oxidation of a chromophore employing hydrogen peroxide as a hydrogen acceptor, and the chromophore is oxidized by the hydrogen peroxide and the peroxidase to produce a color-developing agent having a spectrum in the visible light region.

For example, the substrate of the biological sample, for example, glucose and uric acid, and a color-developing reagent may be reacted as shown in the following Reaction Scheme 1 and Reaction Scheme 2:

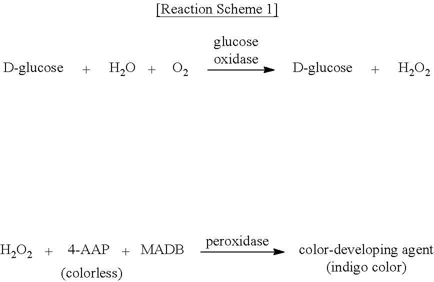

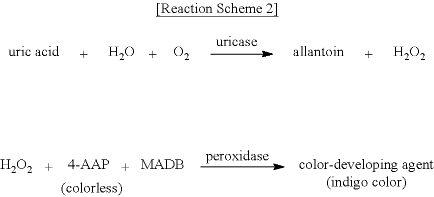

For example, glucose or uric acid produces hydrogen peroxide by glucose oxidase or uricase. The hydrogen peroxide produced as described above is used to produce a color-developing agent to which 4-aminoantipyrine (4-AAP) and N,N-bis(4-sulfobutyl)-3,5-dimethylaniline disodium salt (MADB) are oxidatively bound. This color-developing agent displays a blue color which can be measured at 630 nm, and the amount of a sample may be quantitatively measured by measuring the change in this color.

Two or more detection units may be present, and the detection unit can simultaneously detect two or more substrates.

For example, since an enzyme has a substrate specificity, two or more oxidases each react and may not interfere with each other even in a detection unit in which the two or more oxidases are mixed and included.

For example, when there are two or more detection units on the membrane, detection units each including different types of oxidases may be present, and a substrate of each biological sample may be quantitatively detected by injecting a biological sample in which two or more substrates of the biological sample are mixed.

The detection unit may have a diameter of 0.1 mm to 10 mm, for example, 3 mm.

The detection unit may be absorbed in the membrane at a depth of 10μm to 1000μm, for example, 100μm based on the surface of the membrane.

An aspect of the present invention provides a biological sample analyzer including a colorimetric detection sensor including a porous membrane; and a detection unit formed on the porous membrane and including a water-soluble chitosan derivative and a color-developing reagent.

The porous membrane may be any one selected from the group consisting of nitrocellulose, nylon, polysulfone, polyethersulfone, polyvinylidene fluoride (PVDF), and a combination thereof, for example, nitrocellulose, but is not limited thereto.

The water-soluble chitosan derivative may be any one selected from the group consisting of chitosan oligosaccharide lactate (COL), glycol chitosan (GC), methyl glycol chitosan (MGC), N-carboxymethyl chitosan, N-hydroxymethyl chitosan, N-hydroxypropyl chitosan, N-hydroxypropyl ether chitosan, and a combination thereof, for example, chitosan oligosaccharide lactate (COL).

The color-developing reagent may include an oxidase, a peroxidase, and a chromophore.

The biological sample analyzer may include a colorimetric detection sensor including, for example, an introduction unit into which a biological sample is injected, a detection unit in which the reaction result of the biological sample and a color-developing reagent appears, and a guide unit which connects the introduction unit and the detection unit.

In an exemplary embodiment of the present invention, the colorimetric detection sensor included in the biological sample analyzer includes a water-soluble chitosan derivative and a color-developing reagent, and may confirm the presence and absence of a biological sample substrate by the unaided eye in a short period of time, for example, within 3 minutes, using a porous membrane. The biological sample analyzer may further include, for example, a measuring unit which is capable of measuring the color intensity of the detection unit and a display unit which displays the numerical value of the measured color intensity.

The biological sample analyzer may be in the form of a strip.

The biological sample analyzer may be used for point-of-care testing (POCT).

As used herein, the term “biological sample analyzer” means an apparatus for confirming the presence of a substrate and/or quantitatively analyzing a substrate to be analyzed in a biological sample such as whole blood, serum, plasma, urine or blood. The biological sample analyzer is not limited as long as it is in the form obvious in the art, and may be, for example, a portable device.

As used herein, the “biological sample” means a material derived from an organism, such as a part of blood (for example, plasma or red blood cells), cells, hair, urine, saliva or sweat.

As used herein, the term “substrate of a biological sample” means a material that is brought into contact with a color-developing reagent to cause an enzymatic reaction, and may be, for example, glucose or uric acid.

As used herein, the term “point-of-care testing” is a clinical pathological test which is performed in a place close to a place where a patient receives treatment and refers to a test which is rapidly performed without a pre-treatment of a specimen, such as a centrifugation, in the vicinity of a subject and may be used for diagnosis and treatment.

The point-of-care testing has an advantage in that a result can be rapidly obtained by easily performing a test with a small amount of specimen and that there are few items to be described for specimen confirmation and there is no need for transportation because the test is performed in real time.

An aspect of the present invention provides a method for manufacturing a colorimetric detection sensor, the method including: preparing a detection mixture solution by mixing a water-soluble chitosan derivative and a color-developing reagent; spotting a porous membrane with the detection mixture solution; and forming a detection unit by drying the porous membrane spotted with the detection mixture solution.

First, the present invention includes preparing a detection mixture solution by mixing a chitosan derivative and a color-developing reagent.

The color-developing reagent may include an oxidase, a peroxidase, and a chromophore.

The oxidase may be any one selected from the group consisting of glucose oxidase, galactose oxidase, lactate oxidase, pyruvate oxidase, glutamate oxidase, alcohol oxidase, ascorbate oxidase, cholesterol oxidase, choline oxidase, uricase, and a combination thereof, for example, glucose oxidase, uricase, or a mixed enzyme of glucose oxidase and uricase.

The peroxidase may be any one selected from the group consisting of soybean ascorbate peroxidase, arabidopsis ascorbate peroxidase, spinach ascorbate peroxidase, horseradish peroxidase (HRP), and a combination thereof, for example, horseradish peroxidase (HRP).

The chromophore may be any one selected from the group consisting of tetramethylbenzidine (TMB), 3,3-diaminobenzidine (DAB), 4-aminoantipyrine (4-AAP), N-ethyl-N-(2-hydroxy-3-sulfopropyl)-3,5-dimethylaniline (MAOS), N-ethyl-N-(2-hydroxy-3-sulfopropyl)-3-methoxyaniline (ADOS), N-ethyl-N-(3-sulfopropyl)-3-methoxyaniline (ADPS), N-ethyl-N-(3-sulfopropyl)aniline (ALPS), N-ethyl-N-(2-hydroxy-3-sulfopropyl)-3,5-dimethoxyaniline (DAOS), N-(2-hydroxy-3-sulfopropyl)-3,5-dimethoxyaniline (HDAOS), N,N-bis(4-sulfobutyl)-3,5-dimethylaniline (MADB), N,N-bis(4-sulfobutyl)-3-methylaniline (TODB), N-ethyl-N-(2-hydroxy-3-sulfopropyl)-3-methylaniline (TOOS), N-ethyl-N-(3-sulfopropyl)-3-methylaniline (TOPS), and a combination thereof, for example, a mixture of 4-AAP and N,N-bis(4-sulfobutyl)-3,5-dimethylaniline (MADB).

The water-soluble chitosan derivative may be any one selected from the group consisting of chitosan oligosaccharide lactate (COL), glycol chitosan (GC), methyl glycol chitosan (MGC), N-carboxymethyl chitosan, N-hydroxymethyl chitosan, N-hydroxypropyl chitosan, N-hydroxypropyl ether chitosan, and a combination thereof, for example, chitosan oligosaccharide lactate (COL).

Since the water-soluble chitosan derivative does not need to be mixed with another material for being mixed with a water-soluble color-developing reagent, the effect of color-developing concentration may be easily exhibited.

For example, in the case of hydrophobic chitosan, acetic acid needs to be added in order to be mixed with the water-soluble color-developing reagent, which may reduce color development.

The water-soluble chitosan derivative may be included in an amount of 0.1 wt % to 5 wt %, for example, 3 wt % based on the total amount of the detection mixture solution.

When the water-soluble chitosan derivative is included in an amount of less than 0.1 wt % based on the total amount of the detection mixture solution, color development concentration may not occur well, and when the water-soluble chitosan derivative is included in an amount of more than 5 wt % based on the total amount of the detection mixture solution, color development may not occur because a fluid fails to permeate the detection unit.

Next, the method includes spotting a porous membrane with the detection mixture solution.

The porous membrane may be any one selected from the group consisting of nitrocellulose, nylon, polysulfone, polyethersulfone, polyvinylidene fluoride (PVDF), and a combination thereof, for example, nitrocellulose.

The spotting of the porous membrane with the detection mixture solution may be performed, for example, by a method of drip-dropping a detection mixture solution onto a desired position by putting the detection mixture solution into a dropper.

0.1μL to 5μL, for example, 0.5μL of the detection mixture solution may be drip-dropped. When the amount of the detection mixture solution is less than 0.1μL, the detection mixture solution may not sufficiently react with the biological sample substrate, and when the amount of the detection mixture solution is more than 5μL, the diameter is of the detection unit is so large that the fluid cannot permeate the center of the detection unit.

The detection mixture solution may be drip-dropped with a diameter of 0.1 mm to 10 mm.

Next, the method includes forming a detection unit by drying the porous membrane spotted with the detection mixture solution.

The forming of the detection unit by drying the porous membrane may be performed by drying the porous membrane in a thermo-hygrostat at a temperature of 20° C. to 50° C., for example, 37° C. for 1 minute to 5 minutes, for example, 1 minute and 30 seconds.

The drying of the porous membrane serves to adsorb the detection mixture solution onto the porous membrane.

For example, the detection mixture solution may be adsorbed onto the porous membrane, thereby allowing the chitosan derivative to block pores of the membrane.

Then, when a biological sample is injected into the center of the membrane and the biological sample moves to the end of the membrane along the pores of the membrane, the biological sample cannot move any further in the detection unit and may provide an excellent color developing concentration effect by reacting with a color-developing reagent while staying in the detection unit.

Hereinafter, preferred examples for helping the understanding of the present invention will be suggested. However, it is obvious that the following Examples merely illustrate the present invention, and the scope of the present invention is not limited to the following Examples.

### EXAMPLES

### Preparation Example 1

### Preparation of Detection Mixture Solution

A first mixture solution including a 500 U/mL glucose oxidase (GOx) mixture solution and a 500 U/mL horseradish peroxidase (HRP) mixture solution was prepared by dissolving 3.9 mg of GOx and 3.6 mg of HRP in 1 mL of a phosphate buffer (pH 6.0/7.0).

A 500 mM third mixture solution was prepared by dissolving 10 mg of 4-aminoantipyrine (4-AAP) and 22 mg of N,N-bis(4-sulfobutyl)-3,5-dimethylaniline, disodium salt (MADB) in 100μL of ultrapure water.

A 5 wt % fourth mixture solution was prepared by dissolving 50 mg of chitosan oligosaccharide lactate (COL) in 1 mL of ultrapure water.

A detection mixture solution was prepared by mixing 4μL of the first mixture solution, 4μL of the third mixture solution, and 12μL of the fourth mixture solution.

### Preparation Example 2

### Preparation of Detection Mixture Solution

A second mixture solution including a 1800 U/mL uricase mixture solution and a 500 U/mL horseradish peroxidase (HRP) mixture solution was prepared by dissolving 32.7 mg of uricase and 3.6 mg of HRP in 1μL of a phosphate buffer (pH 6.0/7.0).

A 500 mM third mixture solution was prepared by dissolving 10 mg of 4-aminoantipyrine (4-AAP) and 22 mg of N,N-bis(4-sulfobutyl)-3,5-dimethylaniline, disodium salt (MADB) in 100μL of ultrapure water.

A 5 wt % fourth mixture solution was prepared by dissolving 50 mg of chitosan oligosaccharide lactate (COL) in 1 mL of ultrapure water.

A detection mixture solution was prepared by mixing 4μL of the second mixture solution, 4μL of the third mixture solution, and 12μL of the fourth mixture solution.

### Preparation Example 3

### Preparation of Detection Mixture Solution

A detection mixture solution was prepared by performing the same method as in Preparation Example 1, except that the content of COL in the fourth mixture solution was set to 1.67 wt %.

### Preparation Example 4

### Preparation of Detection Mixture Solution

A detection mixture solution was prepared by performing the same method as in Preparation Example 1, except that the content of COL in the fourth mixed solution was set to 3.33 wt %.

### Preparation Example 5

### Preparation of Detection Mixture Solution

A detection mixture solution was prepared by performing the same method as in Preparation Example 1 except that 1.67 wt % of glycol chitosan (GC) was contained instead of COL during the preparation of the fourth mixture solution.

### Preparation Example 6

### Preparation of Detection Mixture Solution

A detection mixture solution was prepared by performing the same method as in Preparation Example 1, except that 1.67 wt % of methyl glycol chitosan (MGC) was contained instead of COL during the preparation of the fourth mixture solution.

### Comparative Preparation Example 1

### Preparation of Detection Mixture Solution

A detection mixture solution was prepared by performing the same method as in Preparation Example 1, except that COL was not used during the preparation of the fourth mixture solution.

### Comparative Preparation Example 2

### Preparation of Detection Mixture Solution

A detection mixture solution was prepared by performing the same method as in Preparation Example 1, except that 1.67 wt % of chitosan (141 kDa) was contained instead of COL during the preparation of the fourth mixture solution.

### Example 1

### Manufacture of Colorimetric Detection Sensor

After a nitrocellulose (NC) membrane was cut into 2 cm×2 cm, 0.5μL of the detection mixture solution prepared in Preparation Example 1 was drip-dropped onto 6 points of the membrane while drawing a circle with the center of the membrane as a reference, and then a colorimetric detection sensor was manufactured by drying the membrane in a desiccator for 1 minute and 30 seconds.

### Examples 2 to 5

### Manufacture of Colorimetric Detection Sensor

Colorimetric detection sensors were manufactured by performing the same method as in Example 1, except that the detection mixture solutions prepared in Preparation Examples 2, 3, 5, and 6, respectively, were used instead of the detection mixture solution prepared in Preparation Example 1.

### Example 6

### Manufacture of Colorimetric Detection Sensor

A colorimetric detection sensor was manufactured by performing the same method as in Example 1, except that the detection mixture solution prepared in Preparation Example 1 was drip-dropped onto 3 points of the membrane while drawing a semi-circle on the left side of the center of the membrane as a reference and the detection mixture solution prepared in Preparation Example 2 was drip-dropped onto 3 points of the membrane while drawing a semi-circle on the right side of the center of the membrane as a reference.

### Comparative Examples 1 and 2

### Manufacture of Colorimetric Detection Sensor

Colorimetric detection sensors were manufactured by performing the same method as in Example 1, except that the detection mixture solutions prepared in Comparative Preparation Examples 1 and 2, respectively, were used instead of the detection mixture solution prepared in Preparation Example 1.

### Preparation Experimental Example 1

### Determination of Optimized Concentration of Color-Developing Reagent

In order to determine the optimized concentration of the color-developing reagent, the color intensities were compared by adjusting the concentrations of GOx, uricase, HRP, 4-AAP, and MADB included in the color-developing reagent.

i) Experiment: the color intensities were compared by fixing the concentrations of 4-AAP and MADB at 50 Mm and the concentration of HRP at 50 U/mL, setting the concentration of 500 mg/dL GOx to 0 U/mL, 1 U/mL, 2.5 U/mL, 10 U/mL, 25 U/mL, and 50 U/mL, respectively, and setting the concentration of 200 mg/dL uricase to 0 U/mL, 1 U/mL, 10 U/mL, 22.5 U/mL, 45 U/mL, 90 U/mL, and 180 U/mL, respectively.

ii) Experiment: the color intensities were compared by fixing the concentrations of GOx and uricase at 50 U/mL and 180 U/mL, respectively, and varying the concentrations of 4-AAP, MADB, and HRP to 0 mM or U/mL, 1 mM or U/mL, 2.5 mM or U/mL, 10 mM or U/mL, 25 mM or U/mL, and 50 mM or U/mL, respectively.

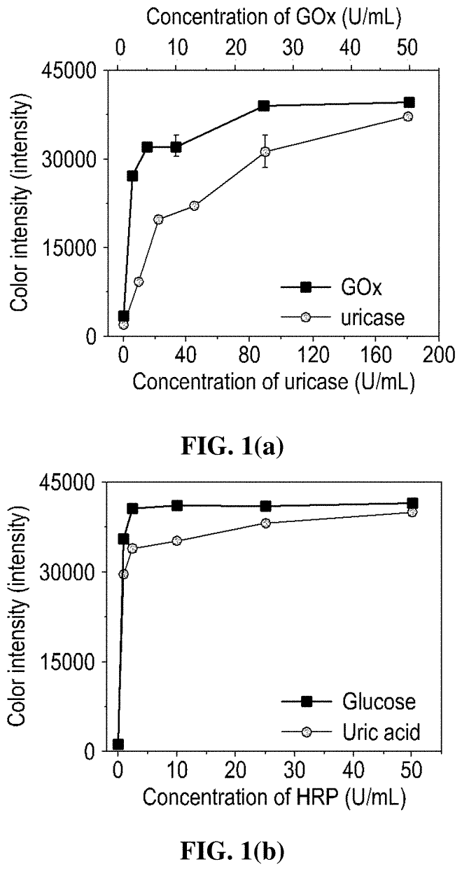

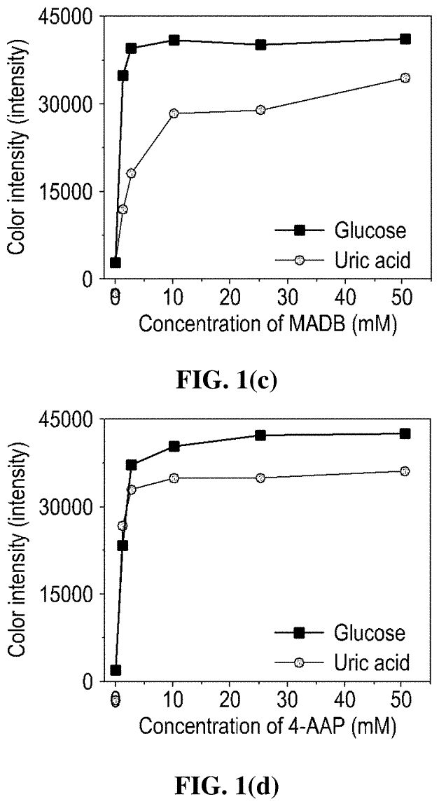

As a result of i) Experiment, it could be seen that the color intensity was increased steadily as the concentrations of GOx and uricase were increased ((a) of FIG. 1). The maximum values of the experimental concentrations were selected for subsequent experiments to account for the concentrations of an excess analyte and the matrix effects of an actual sample: GOx at 50 U/mL and uricase at 180 U/mL

As a result of ii) Experiment, it could be seen that the optimum value was 50 U/mL for HRP and 50 mM for 4-AAP and MADB ((b), (c), and (d) of FIG. 1).

Thereafter, in the experiment of the colorimetric detection sensor, the experiment was performed by setting the concentrations of the coloring reagents GOx, uricase, HRP, and 4-AAP and MADB to 50 U/mL, 180 U/mL, 50 U/mL, and 50 mM, respectively.

### Experimental Example 1

### Observation of Surface of Colorimetric Detection Sensor

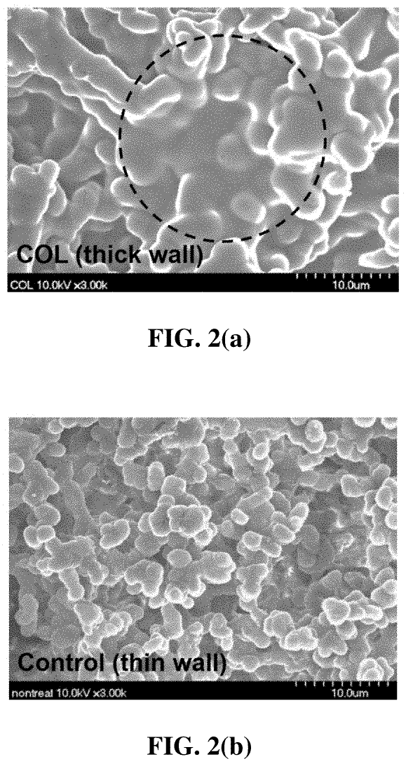

In order to compare the surfaces of the colorimetric detection sensor manufactured in Example 1 ((a) of FIG. 2) and the control ((b) of FIG. 2) which was not treated with the detection mixture solution, the surfaces were observed by a scanning electron microscope.

As a result of the observation, it was found that the thickness of the membrane wall of the membrane was increased and a film was formed between pores in the colorimetric detection sensor manufactured in Example 1 as compared to the control.

### Experimental Example 2

### Confirmation of Detection

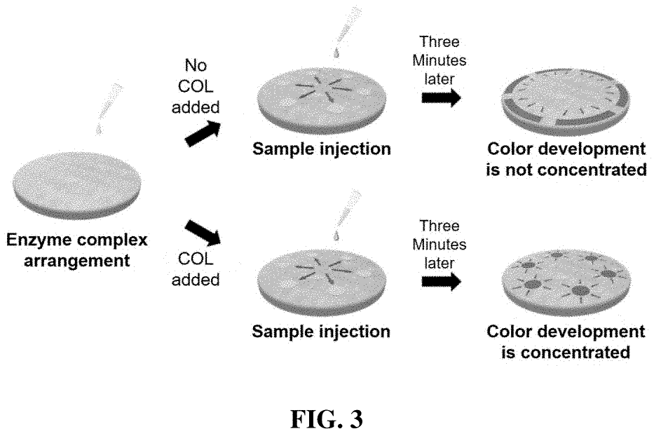

In order to confirm the detection of glucose and uric acid, the color intensity was measured by injecting 55μL of a biological sample solution prepared by dissolving glucose and/or uric acid in ultrapure water (UPW) and human urine (Innovative Research, Novi, USA) into the center of the colorimetric detection sensor manufactured in the Example of the present invention and using Bio Rad Universal Hood III (Bio Rad Laboratories, Inc., Hercules, Calif.) three minutes later (FIG. 3).

### 2.1. Comparison with Chitosan Derivative

The above experiments were performed by injecting a biological sample solution in which human urine and ultrapure water were mixed into the colorimetric detection sensors manufactured in Examples 3, 4, and 5 and Comparative Examples 1 and 2.

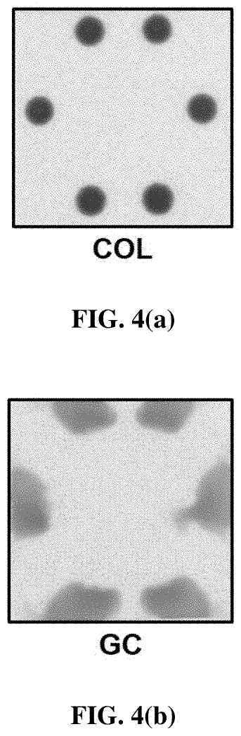

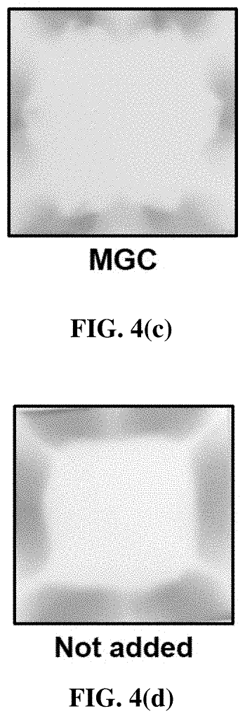

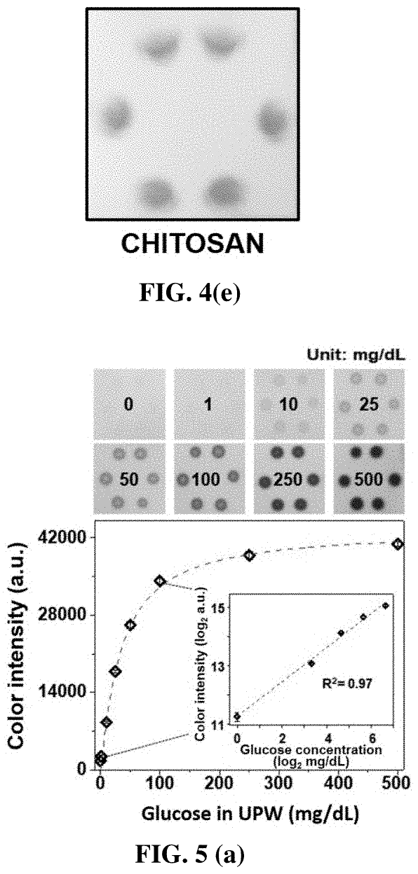

As a result of the experiment, when the colorimetric detection sensor with COL added was used, it could be confirmed that the color developing concentration effect was the greatest ((a) of FIG. 4), when GC, MGC, and a water-soluble chitosan derivative were not added, it could be confirmed that the detection mixture solution moved from the colored center to the end of the membrane, and thus, the color development was not concentrated ((b), (c), and (d) of FIG. 4), and when chitosan was added, the color developing concentration effect was insufficient, chitosan had to be dissolved using acetic acid because chitosan has low solubility for ultrapure water, and it could be confirmed that for this reason, the color development of the enzyme was reduced ((e) of FIG. 4).

### 2.2. Confirmation of Quantitativeness of Detection

Measured values of 1 mg/dL of a glucose level and 17 mg/dL of a uric acid level were obtained from human urine using a 7020 automatic analyzer (Hitachi, Tokyo, Japan).

i) Experiment: the above experiments were performed by injecting solutions in which the content of glucose in ultrapure water was set to 0 mg/dL, 1 mg/dL, 10 mg/dL, 25 mg/dL, 50 mg/dL, 100 mg/dL, 250 mg/dL, and 500 mg/dL respectively, and biological sample solutions in which the content of uric acid in ultrapure water was set to 0 mg/dL, 1 mg/dL, 10 mg/dL, 25 mg/dL, 50 mg/dL, 100 mg/dL, and 200 mg/dL, respectively, into the colorimetric detection sensors manufactured in Examples 1 and 2.

ii) Experiment: The same experiment as in i) Experiment was performed, except that the biological sample solutions in which human urine was set to 0 mg/dL, 1 mg/dL, 10 mg/dL, 25 mg/dL, 50 mg/dL, 100 mg/dL, 250 mg/dL, and 500 mg/dL were injected into the colorimetric detection sensor manufactured in Example 1.

iii) Experiment: A quantification experiment was performed in spiked human urine to confirm the susceptibility of glucose and uric acid under actual field investigation conditions.

The concentration of glucose was adjusted to 1 mg to 500 mg, the concentration of uric acid was adjusted to 17 mg to 200 mg, and individual biological sample solutions were analyzed by the colorimetric detection sensors manufactured in Example 1 and Example 2.

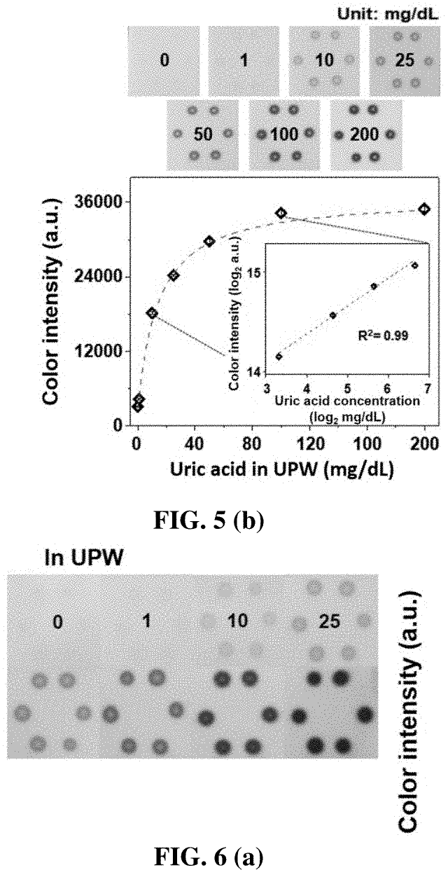

As a result of i) Experiment, it could be seen that R² of glucose and uric acid was 0.997 and 0.967, respectively, and the detection limit was 0.4 mg/dL (22μM) and 0.09 mg/dL (5.3μM), respectively ((a) and (b) of FIG. 5).

In the case of a colorimetric detection sensor manufactured by the already known vapor deposition method, it could be seen that glucose and uric acid could be detected at low concentrations compared to a detection limit of glucose of about 25 mg/dL and a detection limit of uric acid of about 2.2 mg/dL.

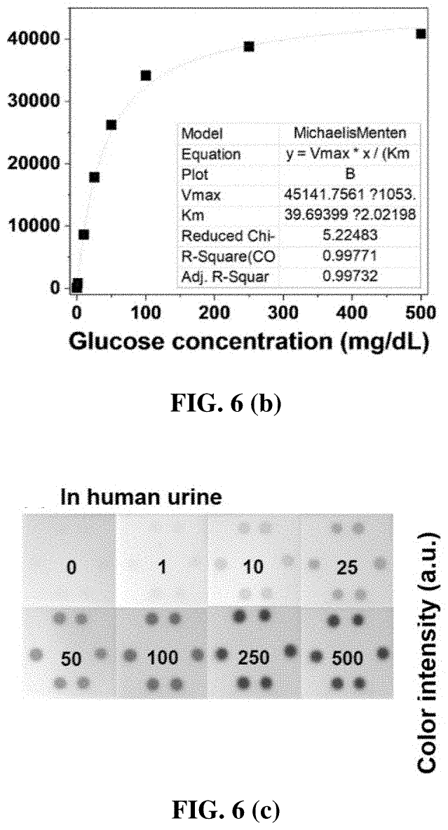

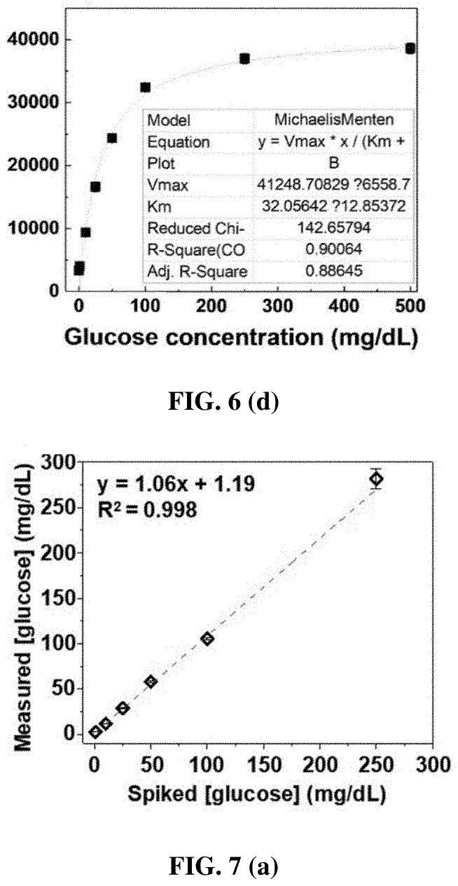

As a result of ii) Experiment, it could be seen that R² of glucose dissolved in UPW and glucose of human urine was 0.997 and 0.901, respectively (FIG. 6).

As a result of i) Experiment and ii) Experiment, it could be seen that the colorimetric concentration occurred and the color intensity was increased as the concentration of the sample was increased, it could be confirmed that both i) Experiment and ii) Experiment fit well with the Michaelis-Menten model, and it could be seen that the developed sensor could sufficiently detect glucose and uric acid in a range of normal and abnormal levels, considering that the normal ranges of glucose and uric acid values of human urine are 0 mg/dL to 14.4 mg/dL and 24.8 mg/dL to 74.4 mg/dL, respectively.

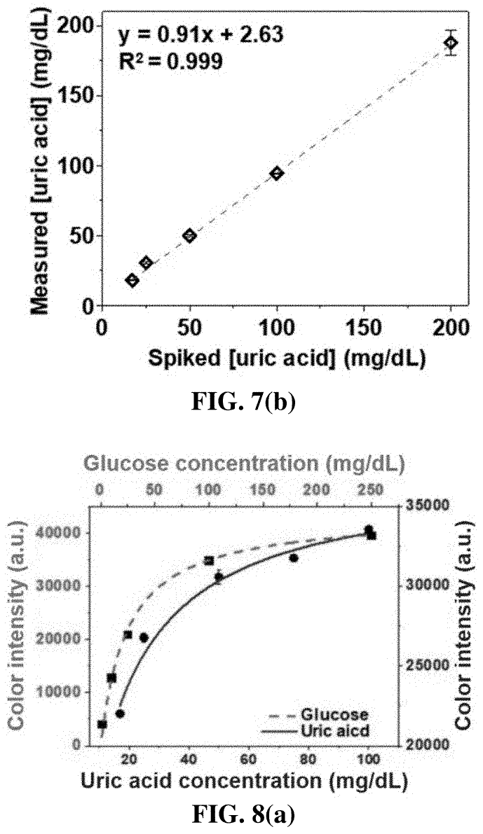

As a result of iii) Experiment, it could be seen that the R² value of glucose and uric acid was 0.998 and 0.999, respectively (FIG. 7), and the coefficients of variation (CV) of the two biological sample solutions at the same concentration were 5% or less in all cases. Through this, it was confirmed that it was possible to make a colorimetric detection sensor suitable for actual application in actual point-of-care testing without using a complicated and time-consuming patterning method.

### 2.3. Confirmation of Multiple Detection

In Experimental Example 2, it was confirmed that a multiple detection could be achieved by using the colorimetric detection sensor manufactured in Example 6 and using, as a substrate sample, a biological sample solution obtained by setting the concentration of glucose to 1 mg/dL, 10 mg/dL, 25 mg/dL, 100 mg/dL, and 250 mg/dL and the concentration of uric acid to 17 mg/dL, 25 mg/dL, 50 mg/dL, 75 mg/dL, and 100 mg/dL to dissolve glucose and uric acid in ultrapure water. Experiments were performed with direct and inverse slopes.

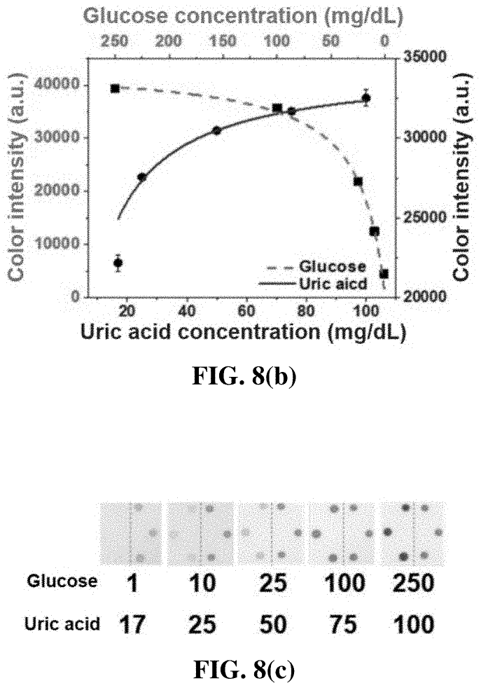

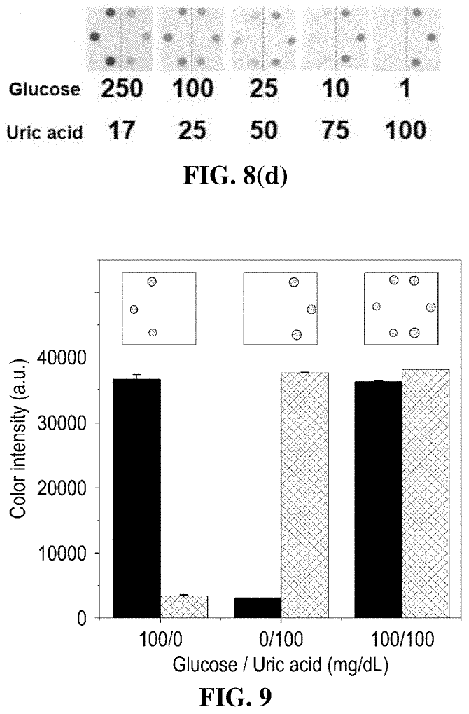

As a result of the experiment, each enzyme was found to react specifically with the substrate without any interference, it could be confirmed that the color intensity was gradually increased depending on the concentration ((a) and (b) of FIG. 8), and the corresponding sensing range and R² values were found to be 1 mg/dL to 250 mg/dL and 0.960 for glucose and 17 mg/dL to 100 mg/dL and 0.984 for uric acid.

Under inverse slope change conditions, it could be seen that the R² values of glucose and uric acid were quantified as 0.961 and 0.969, respectively, and a dramatic cross-curve of glucose and uric acid could be observed ((c) and (d) of FIG. 8).

Further, the difference between the visualized color intensities on the membrane could be distinguished by the unaided eye, and in the case of glucose and uric acid, very similar color concentrations are obtained at the same concentration of the biological sample solutions, and the relative standard deviation (RSD) between the results of the direct and inverse slope tests was calculated to be less than 2%.

As a result, the high color reproducibility of the colorimetric detection sensor of the present invention was confirmed, and it could be seen that the colorimetric concentration sensor of the present invention is suitable for simultaneously quantifying the detection of two substrates.

### 2.4. Confirmation of Multiple Detection

In Experimental Example 2, it was confirmed that a multiple detection could be achieved by using the colorimetric detection sensor manufactured in Example 6 and using, as a substrate sample, a biological sample solution obtained by setting the concentrations of glucose and uric acid to i) 100 mg/dL and 0 mg/dL, ii) 0 mg/dL and 100 mg/dL, and iii) 100 mg/dL and 100 mg/dL, respectively, to dissolve glucose and uric acid in ultrapure water.

As a result of the experiment, it was confirmed that each enzyme reacted specifically with the substrate without any interference (FIG. 9).

### Experimental Example 3

### Stability Experiment

After exposing the detection units of the colorimetric detection sensors manufactured in Example 1 and Comparative Example 1 to the atmosphere under the room temperature conditions for 30 days, a biological sample solution of glucose and uric acid was injected, and the color intensity was confirmed after 0, 1, 2, 3, 4, 7, 14, and 30 days.

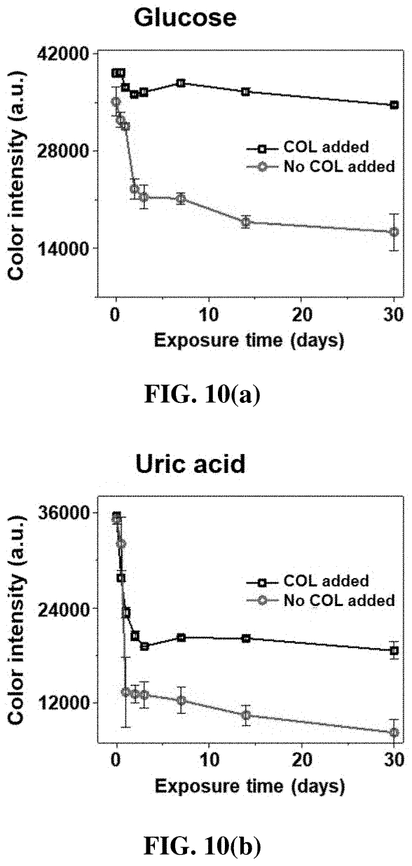

As a result, it could be confirmed that during the experiment of glucose detection, the color intensity after 30 days was decreased by 12% in the case of the colorimetric detection sensor manufactured in Example 1, whereas the color intensity after 30 days was decreased by 53% in the case of the colorimetric detection sensor manufactured in Comparative Example 1 ((a) of FIG. 10), and it could be confirmed that during the experiment of uric acid detection, the color intensity after 30 days was decreased by 52% in the case of the colorimetric detection sensor manufactured in Example 1, whereas the color intensity after 30 days was decreased by 72% in the case of the colorimetric detection sensor manufactured in Comparative Example 1 ((b) of FIG. 10).

Therefore, it could be confirmed that the safety of the colorimetric detection sensor containing COL was better than that of the colorimetric detection sensor containing no COL.

The present invention can provide a color development-concentrated colorimetric detection sensor including a detection unit, in which a water-soluble chitosan derivative and a chromophore are mixed, present on a porous membrane, wherein the enzyme stability is improved, a quantitative detection can be performed, and the size, position, and the like of the detection unit can be adjusted.

The effect of the present invention is not limited to the aforementioned effects, and it should be understood to include all possible effects deduced from the configuration of the invention described in the detailed description or the claims of the present invention.

The above-described description of the present invention is provided for illustrative purposes, and the person skilled in the art to which the present invention pertains will understand that the present invention can be easily modified into other specific forms without changing the technical spirit or essential features of the present invention. Therefore, it should be understood that the above-described embodiments are only exemplary in all aspects and are not restrictive. For example, each constituent element which is described as a singular form may be implemented in a distributed form, and similarly, constituent elements which are described as being distributed may be implemented in a combined form.

The scope of the present invention is represented by the claims to be described below, and it should be interpreted that the meaning and scope of the claims and all the changes or modified forms derived from the equivalent concepts thereof fall within the scope of the present invention.

What is claimed is:

1. A colorimetric detection sensor comprising:
a porous membrane; and
a detection unit formed on the porous membrane and comprising a water-soluble chitosan derivative and a color-developing reagent.

2. The colorimetric detection sensor of claim 1, wherein the water-soluble chitosan derivative is any one selected from the group consisting of chitosan oligosaccharide lactate (COL), glycol chitosan (GC), methyl glycol chitosan (MGC), N-carboxymethyl chitosan, N-hydroxymethyl chitosan, N-hydroxypropyl chitosan, N-hydroxypropyl ether chitosan, and a combination thereof.

3. The colorimetric detection sensor of claim 1, wherein the water-soluble chitosan derivative has a molecular weight of 1 kDa to 150 kDa.

4. The colorimetric detection sensor of claim 1, wherein the water-soluble chitosan derivative blocks pores of the porous membrane.

5. The colorimetric detection sensor of claim 1, wherein the porous membrane comprises any one selected from the group consisting of nitrocellulose, nylon, polysulfone, polyethersulfone, polyvinylidene fluoride (PVDF), and a combination thereof.

6. The colorimetric detection sensor of claim 1, wherein the color-developing reagent comprises an oxidase, a peroxidase, and a chromophore.

7. The colorimetric detection sensor of claim 6, wherein the oxidase comprises any one selected from the group consisting of glucose oxidase, galactose oxidase, lactate oxidase, pyruvate oxidase, glutamate oxidase, alcohol oxidase, ascorbate oxidase, cholesterol oxidase, choline oxidase, uricase, and a combination thereof.

8. The colorimetric detection sensor of claim 6, wherein the peroxidase comprises any one selected from the group consisting of soybean ascorbate peroxidase, arabidopsis ascorbate peroxidase, spinach ascorbate peroxidase, horseradish peroxidase (HRP), and a combination thereof.

9. The colorimetric detection sensor of claim 6, wherein the chromophore comprises any one selected from the group consisting of tetramethylbenzidine (TMB), 3,3-diaminobenzidine (DAB), 4-aminoantipyrine (4-AAP), N-ethyl-N-(2-hydroxy-3-sulfopropyl)-3,5-dimethylaniline (MAOS), N-ethyl-N-(2-hydroxy-3-sulfopropyl)-3-methoxyaniline (ADOS), N-ethyl-N-(3-sulfopropyl)-3-methoxyaniline (ADPS), N-ethyl-N-(3-sulfopropyl)aniline (ALPS), N-ethyl-N-(2-hydroxy-3-sulfopropyl)-3,5-dimethoxyaniline (DAOS), N-(2-hydroxy-3-sulfopropyl)-3,5-dimethoxyaniline (HDAOS), N,N-bis(4-sulfobutyl)-3,5-dimethylaniline (MADB), N,N-bis(4-sulfobutyl)-3-methylaniline (TODB), N-ethyl-N-(2-hydroxy-3-sulfopropyl)-3-methylaniline (TOOS), N-ethyl-N-(3-sulfopropyl)-3-methylaniline (TOPS), and a combination thereof.

10. The colorimetric detection sensor of claim 1, wherein two or more detection units are present, and the detection unit is capable of simultaneously detecting two or more substrates.

11. A biological sample analyzer comprising the colorimetric detection sensor of claims 1.

12. The biological sample analyzer of claim 11, wherein the biological sample analyzer is capable of point-of-care testing (POCT).

13. A method for manufacturing a colorimetric detection sensor, the method comprising:
preparing a detection mixture solution by mixing a water-soluble chitosan derivative and a color-developing reagent;
spotting a porous membrane with the detection mixture solution; and
forming a detection unit by drying the porous membrane spotted with the detection mixture solution.

14. The method of claim 13, wherein the color-developing reagent comprises an oxidase, a peroxidase, and a chromophore.

15. The method of claim 13, wherein the water-soluble chitosan derivative is included in an amount of 0.1 wt % to 5 wt % based on the total amount of the detection mixture solution.

16. The method of claim 13, wherein the detection mixture solution is spotted at 0.1μL to 5μL.
